(19) United States
(12) Patent Application Publication
(10) Pub. No.: US 2012/0102125 A1
(43) Pub. Date: Apr. 26, 2012

(54) METHOD, APPARATUS, AND COMPUTER PROGRAM PRODUCT FOR SCREENED COMMUNICATIONS

(76) Inventors: Jeffrey Albert Dracup, San Diego, CA (US); Alexander Patterson Dracup, San Diego, CA (US)

(21) Appl. No.: 13/277,162

(22) Filed: Oct. 19, 2011

Related U.S. Application Data
(60) Provisional application No. 61/394,774, filed on Oct. 20, 2010.

(51) Int. Cl. G06F 15/16

(52) U.S. Cl. 709/206

(57) ABSTRACT

The present invention provides a method using one or more computers when conducting screened communications. The invention may comprise locating a first user and allowing other users to access the first user's personal attributes while allowing the first user to access the personal attributes of the other users. The users may filter potential communication participants based on each user's preferences and relative rankings regarding personal attributes of other users. More than one communication levels, with different communication formats, may be provided for a user to communicate with other users. A user may use the system to locate a particular type of person and/or venues with specific attributes. A user may use the system anonymously or with a pseudonym. Users may communicate at a particular location with or without observing another user at the particular location or at a different location.

### CROSS-REFERENCE TO RELATED APPLICATION

The application claims priority from U.S. Provisional Patent Application No. 61/394,774, filed on Oct. 20, 2010, the contents of which are incorporated herein by reference.

### BACKGROUND OF THE INVENTION

The present invention relates generally to operation of a social introduction and communication service. Specifically, the invention relates to initiating an electronic conversation between a first user and at least one other user selected by the first user before or after filtering transmitted identifying information according to attributes selected by the located user. The first user may seek other users present at a particular location.

Electronic matching services exist, often via networks, to identify and bring together two or more people that somehow indicate a desire to initiate a conversation for social, business, or other reasons. Many such services attempt to make matches based on interests, beliefs, goals, background, history, race, ethnicity, and personalities. However, these matching services do not often account for advance on-site assessments made from observations at particular locations.

Upon observing a person (perhaps via images of a person), many matching services allow users to communicate via telephone, by email, text message, web services, or even in person. However, such matching services do not have systems or facilities to permit users to observe other users live, perhaps interacting with other users. Also, not everyone is comfortable communicating with a new person openly, for reasons of shyness, confidentiality, avoidance of encouraging stalking behavior, and other reasons. Many users may seek to initiate conversations without the embarrassment of public rejection in a bar, restaurant, concert location, classroom, or other venue. Thus, many users are desirable of engaging in a gradual communication before engaging in a more personal introduction to strangers.

Portable devices are increasingly used for multiple tasks that range from telephony to video to computing to audio and other entertainment and instructional uses. Portable devices may be used to facilitate communication, including via a communication service. Such devices may include mobile telephones, personal digital assistants (PDAs), portable video/music players, electronic books, electronic book readers, tablet computers, portable gaming devices, and the like. Some of such devices include the iPad (trademarked by Apple, Inc.), the iPod (trademarked by Apple, Inc.), the iPhone (trademarked by Apple, Inc.), the BlackBerry (trademarked by RIM, Inc.), the Android (trademarked by Google, Inc.), Android-based devices, and other portable devices.

It would be advantageous to provide a communications service that would include one or more of the features of 1) detecting (or establishing or allowing entry of) a user's location; 2) assigning identifying information to the user (or allowing identifying information to be entered by a user); 3) assigning identifying information to other users (or allowing users to enter identifying information) at the approximate same location of the located user; 4) filtering the transmitted identifying information according to attributes selected by the located user; and 5) initiating an electronic conversation between the located user and at least one of the other users selected by the located user.

### SUMMARY OF THE INVENTION

In one aspect of the present invention, a method for operating a communications service comprises determining the location of users, via geo-positional searching (GPS), WiFi signals, signal triangulation, and/or user registration; assigning identifying information to the located user; communicating with a computer server to store the user location and assigned identifying information; retrieving a list from a computer of other users at the approximate same location of the located user; assigning identifying information to the other users at the approximate same location of the located user; transmitting the identifying information of the other users to the located user; filtering the transmitted identifying information according to attributes selected by the located user; initiating an electronic conversation between the located user and at least one of the other users selected by the located user. The determining step may comprise geo-positional searching (GPS), signal triangulation, WiFi signals, navigational methods, and/or user registration.

A located user may provide a response to an option to ignore, respond to, or block contact with one or more of the other users. One may desire to encounter new potential users and incorporate the new users into a list of contacts for further communication. New users may be added to a list of users while at a particular location or at a plurality of locations.

In another aspect of the present invention, the communicating step occurs via one or more of MMS, SMS, text messaging, Internet, website, radio, telephone, telegraph, television, video, or other suitable forms of communication.

In a further aspect of the present invention, the electronic conversation in the initiating step occurs via one or more of MMS, SMS, text messaging, Internet, website, radio, telephone, telegraph, television, video display, or other suitable methods.

In a still further aspect of the present invention, the located user provides a response to an option to ignore, respond to, or block contact (temporarily or permanently) with one or more of the other users. The users may be one of members of a created virtual community network and/or non-members of a created virtual community network.

In yet another aspect of the present invention, an apparatus may comprise a processor; the processor configured to receive an invitation from an inviter to execute at least a part of a software application; execute at least part of the software application; and reveal an identifying characteristic of the inviter to an invitee/challengee. The identity of the inviter may be revealed.

The invention may further comprise receiving an invitation from an inviter. Also, an inviter may reveal an identifying characteristic of the inviter to an invitee. If desired, the invitee may reveal an identifying characteristic of the invitee to the inviter, Inviters and invitees may choose what and how much of any information (such as identifying characteristics) to provide into the system and/or to other users. Various users may reveal information regarding certain users to other users.

Several social media arrangements rely on a user communicating with an established group of “friends” or users. While the present invention permits ongoing communication with lists of users and associates, the present invention also facilitates interacting with others that are possibly unacquainted with a particular user. Invitations, challenges, and other communications may facilitate introductions using the present invention.

The processor may be further configured to receive a request to prepare an invitation/challenge to an additional invitee/challengee; prepare the invitation/challenge to the additional invitee/challengee; submit a request to transmit the invitation/challenge to the additional invitee/challengee; and monitor the status of the invitation/challenge.

The apparatus may further comprise a challenge generator that generates a challenge to elicit a response from a first viewer, one or more second viewers, one or more third viewers and one or more nth viewers; a challenge-response module that determines whether the first viewer, the one or more second viewers, the one or more third viewers, and the one or more nth viewers have entered a response to the challenge to confirm whether the challenge has been reviewed by the first viewer, the one or more second viewers, the one or more third viewers, and the one or more nth viewers respectively; and a report generation module that generates a response report for each of the first viewer, the one or more second viewers, the one or more third viewers, and the one or more nth viewers based on the response from the first viewer the one or more second viewers, the one or more third viewers, and the one or more nth viewers.

In still yet a further aspect of the present invention, a computer program product comprising computer-readable program code portions may comprise a first program code portion configured to receive notification of an invitation via a software application; a second program code portion configured to prepare an invitation; and a third program code portion configured to transmit the invitation to an invitee/challengee to allow the invitee/challengee to access at least a portion of the software application.

The third program code portion may further comprise a program code portion to transmit the invitation via short message service message, multimedia messaging service message, electronic mail, or other messaging protocol. The third program code portion may be configured to reveal an identifying characteristic of the inviter/challenger to an invitee/challengee. The computer program product may further comprise a fourth program code portion for confirming viewing of the invitation/challenge by the invitee/challengee.

These and other aspects, objects, features and advantages of the present invention, are specifically set forth in, or will become apparent from, the following detailed description of an exemplary embodiment of the invention when read in conjunction with the accompanying drawings.

### BRIEF DESCRIPTION OF THE DRAWINGS

FIG. 1 is a schematic block diagram of a mobile communication device, according to an embodiment of the present invention;

FIG. 2 is a block diagram of an apparatus for screening communications, according to an embodiment of the present invention;

FIG. 3 is a block diagram of network components, according to an embodiment of the present invention;

FIG. 4 is a flowchart of a method, according to another embodiment of the present invention;

FIG. 5 is a flowchart of another method, according to another embodiment of the present invention; and

FIG. 6 is a flowchart of yet another method, according to another embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

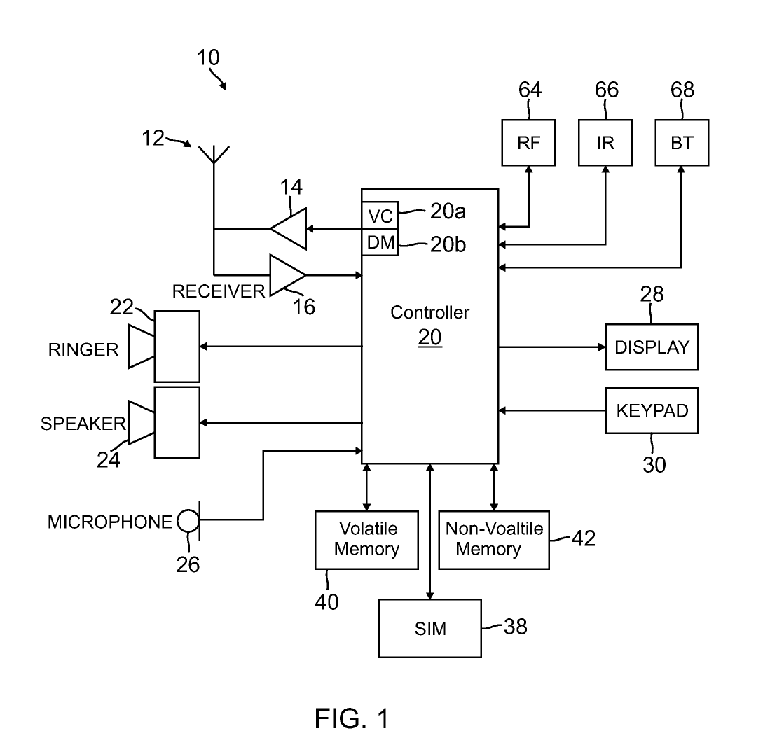

Referring now to the drawings in detail, wherein like reference characters refer to like elements, there is shown in FIG. 1 a block diagram of a mobile communication device 10 that may benefit from embodiments of the present invention. It should be understood, however, that the mobile communication device shown and hereinafter described is merely illustrative of one type of electronic device that may benefit from embodiments of the present invention and, therefore, should not be taken to limit the scope of the present invention. While several embodiments of an electronic device are illustrated and will be hereinafter described for purposes of example, other types of electronic devices, such as mobile telephones, mobile computers, portable digital assistants (PDAs), pagers, laptop computers, desktop computers, tablet computers gaming devices, televisions, and other types of electronic systems, may employ the present invention.

As shown, the mobile communication device 10 may include an antenna 12 in communication with a transmitter 14 and a receiver 16. The mobile communication device 10 may also include a controller 20 or other processor that provides signals to and from the transmitter and receiver, respectively. These signals may include signaling information according to an air interface standard of an applicable cellular or other mobile system, and/or any number of different wireless networking techniques, comprising but not limited to Wireless-Fidelity (Wi-Fi), wireless LAN (WLAN) techniques such as IEEE 802.11 and/or the like. Additionally, these signals may include speech data, user-generated data, user-requested data, and/or the like. The mobile communication device 10 may be capable of operating with one or more air interface standards, communication protocols, modulation types, access types, and/or the like. More particularly, the communication device 10 may be capable of operating according with various first generation (1G), second generation (2G), 2.5G, third-generation (3G) communication protocols, 3.9G, fourth-generation (4G) communication protocols, and/or the like. For example, the mobile communication device 10 may be capable of operating in accordance with 2G wireless communication protocols IS-136 (TDMA), GSM, and IS-95 (CDMA). For example, the mobile communication device 10 may be capable of operating in accordance with 2.5G wireless communication protocols GPRS, EDGE, or the like. Further, for example, the mobile terminal may be capable of operating in accordance with 3G wireless communication protocols such as UMTS, CDMA2000, WCDMA and TD-SCDMA. The mobile communication device 10 may be additionally capable of operating in accordance with 3.9G wireless communication protocols such as LTE or E-UTRAN. Additionally, for example, the mobile communication device 10 may be capable of operating in accordance with fourth-generation (4G) wireless communication protocols or the like as well as similar wireless communication protocols that may be developed in the future.

Some Narrow-band Advanced Mobile Phone Systems (VAMPS), as well as Total Access Communication Systems (TACS), and mobile communication devices may also benefit from embodiments of this invention, as should dual or higher mode phones (e.g., digital/analog or TDMA/CDMA/analog phones). Furthermore, the mobile communication device 10 may be capable of operating according to Wireless Fidelity (Wi-Fi) protocols. It is understood that the controller 20 may comprise the circuitry desirable for implementing audio and logic functions of the mobile terminal 10. In one example, the controller 20 may comprise a digital signal processor device, a microprocessor device, an analog-to-digital converter, a digital-to-analog converter, and/or the like. Any control and signal processing functions of the mobile communication device 10 may be allocated between these devices according to the respective capabilities. The controller may additionally comprise an internal voice coder (VC) 20a, an internal data modem (DM) 20b, and/or the like. Furthermore, the controller may comprise functionality to operate one or more software programs, which may be stored in memory. For example, the controller 20 may be capable of operating a connectivity program, such as a Web browser. The connectivity program may allow the mobile communication device 10 to transmit and receive Web content, such as location-based content, according to a protocol, such as Wireless Application Protocol (WAP), hypertext transfer protocol (HTTP), and/or the like. The mobile communication device 10 may be capable of using a Transmission Control Protocol/Internet Protocol (TCP/IP) to transmit and receive Web content across the Internet.

The mobile communication device 10 may also comprise a user interface including a conventional earphone or speaker 24, a ringer 22, a microphone 26, a display 28, a user input interface, and/or the like, which may be coupled to the controller 20. Although not shown, the mobile communication device 10 may comprise a battery for powering various circuits related to the mobile communication device 10, for example, a circuit to provide mechanical vibration as a detectable output. The user input interface may comprise devices allowing the mobile communication device 10 to receive data, such as a keypad 30, a touch display (not shown), a joystick (not shown), and/or other input device. In embodiments including a keypad, the keypad may comprise conventional numeric (0-9) and related keys (#, *, and/or other keys for operating the mobile terminal.

As shown in FIG. 1, the mobile communication device 10 may also include one or more means for sharing and/or obtaining data. For example, the mobile communication device 10 may comprise a short-range radio frequency (RF) transceiver and/or interrogator 64 so data may be shared with and/or obtained from electronic devices in accordance with RF techniques. The mobile communication device 10 may comprise other short-range transceivers, such as, for example an infrared (IR) transceiver 66, a Bluetooth™ (BT) transceiver 68 operating using Bluetooth™ brand wireless technology developed by the Bluetooth™ Special Interest Group, and/or the like. The Bluetooth transceiver 68 may be capable of operating according to Wibree™ radio standards. In this regard, the mobile communication device 10 and, in particular, the short-range transceiver may be capable of transmitting data to and/or receiving data from electronic devices within a proximity of the mobile terminal, such as within 10 meters or more, for example. Although not shown, the mobile communication device 10 may be capable of transmitting and/or receiving data from electronic devices according to various wireless networking techniques, including Wireless Fidelity (Wi-Fi), WLAN techniques such as IEEE 802.11 techniques, and/or the like.

The mobile communication device 10 may comprise memory, such as a subscriber identity module (SIM) 38, a removable user identity module (R-UIM), and/or the like, which may store information elements related to a mobile subscriber. In addition to the SIM, the mobile communication device 10 may comprise other removable and/or fixed memory. In this regard, the mobile terminal may comprise volatile memory 40, such as volatile Random Access Memory (RAM), which may comprise a cache area for temporary storage of data. The mobile communication device 10 may comprise other non-volatile memory 42, which may be embedded and/or may be removable. The non-volatile memory may comprise an EEPROM, flash memory, and/or the like. The various memories may store one or more software programs, instructions, pieces of information, data, and/or the like which may be used by the mobile communication device 10 for performing functions of the mobile communication device 10. For example, the memories may comprise an identifier, such as an international mobile equipment identity (IMEI) code, capable of uniquely identifying the mobile communication device 10.

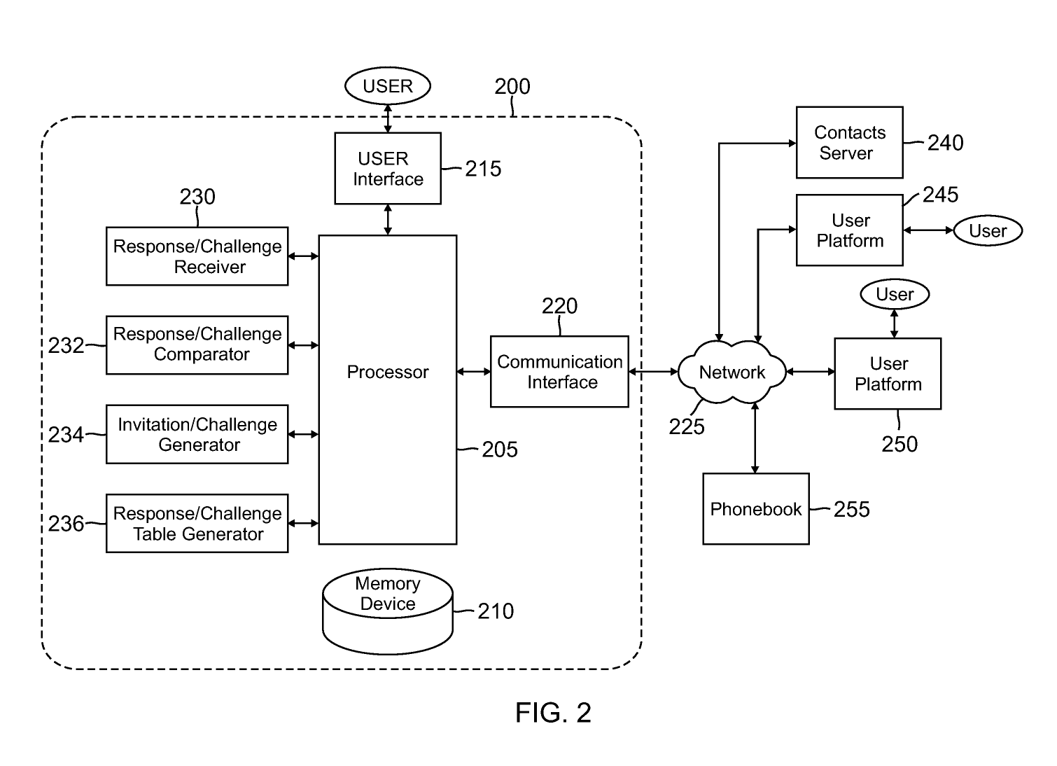

Referring now to FIG. 2, an example apparatus 200 for providing software application invitations is described. Apparatus 200 may be embodied as a network element, e.g. a server, or other network device including, for example, a mobile terminal, such as mobile communication device 10 of FIG. 1. The apparatus 200 may include, or otherwise be in communication with, a processor 205, a user interface 215, a communication interface 220, and/or a memory device 210. The memory device 210 may include, for example, volatile and/or non-volatile memory (e.g., volatile memory 40 and/or non-volatile memory 42). The memory device 210 may be accessed via a local network or otherwise available remotely. In other embodiments, the memory device 210 may be separate from apparatus 200 but may be accessed by apparatus 200 locally, such as, for example, a memory card, Secure Digital (“SD”) card, and/or the like, via a local network, or otherwise available remotely. The memory device 210 may be configured to store information, data, applications, instructions, or the like for enabling the apparatus to carry out various functions in accordance with example embodiments of the present invention.

For example, the memory device 210 could be configured to buffer input data for processing by the processor 205. Additionally or alternatively, the memory device 210 may be configured to store instructions for execution by the processor 205. As another alternative, the memory device 210 may be one of a plurality of databases that store information in the form of static and/or dynamic information, for example, in association with user contacts, one or more response tables, a log of software applications invitations, and/or the like.

The processor 205 may be embodied in various ways. For example, the processor 205 may be embodied as various processing means including a microprocessor, a coprocessor, a controller (e.g., controller 30 from FIG. 1), or various other processing elements including integrated circuits such as, for example, an ASIC (application specific integrated circuit) or FPGA (field programmable gate array). In another example embodiment, the processor 205 may be configured to execute instructions stored in the memory device 210 or otherwise accessible to the processor 205.

The user interface 215 may be in communication with the processor 205 to receive an indication of a user input at the user interface 215 and/or to provide an audible, visual, mechanical, or other output to the user. The user interface 215 may include, for example, a keyboard, a mouse, a joystick, a touch screen display, a conventional display, a microphone, a speaker, or other input/output mechanisms. For example, in an embodiment in which the apparatus 200 is embodied as a mobile terminal (e.g., the mobile communication device 10 of FIG. 1), the user interface 215 may include, among other devices or elements, any or all of the speaker 24, the ringer 22, the microphone 26, the display 28, and the keyboard 30. In an exemplary embodiment in which the apparatus 200 is embodied as a server, the user interface 215 may be limited, or even eliminated.

The communication interface 220 may be embodied as any device or means embodied in either hardware, software, or a combination of hardware and software that is configured to receive and/or transmit data from/to a network and/or any other device or module in communication with the apparatus 200. The communication interface 220 may include, for example, an antenna, a transmitter, a receiver, a transceiver, a network card, network adapter, network interface card and/or supporting hardware or software for enabling communications with network 225, which may be any type of wired or wireless network. The communication interface 220 may enable the receipt and transmission of communications using remote devices (e.g., a contacts server 240, a user platform 245 and 250, or the like). For example, in an embodiment in which the apparatus 200 is embodied as a mobile terminal (e.g., the mobile communication device 10 of FIG. 1), the communication interface 225 may include, among other devices or elements, any or all of an antenna 12, a transmitter 14, a receiver 16, a radio frequency (RF) transceiver and/or interrogator 64, an infrared (IR) transceiver 66, a Bluetooth™ (BT) transceiver 68, an internal voice coder (VC) 20a, and an internal data modem (DM) 20b.

As used herein, “communications” and “communication events” may be used interchangeably and may include, but are not limited to, telephone calls, short message service (SMS) messages, multimedia messaging service (MMS) messages, e-mails, Internet Protocol communication and/or the like, and transfer or other sharing of files between the apparatus 200 and the remote devices. Sometimes as used herein, the generic term “messages” may be used to refer to SMS messages, MMS messages, e-mails, text messages, file transfers and/or the like. As such, via the communication interface 220 and the network 225, the apparatus 200 may communicate with the contacts server 240, the user platform 245, and/or the user platform 250.

As noted above, the apparatus 200 may be configured to communicate with a contacts server 240. The contacts server 240 may be any type of computing device for storing, retrieving, computing, transmitting, and receiving data. The contacts server 240 may include a memory device, a processor, and a communication interface for communicating with the network 225. In some embodiments, the contacts server 240 may be a web server, database server, file server, or the like. According to various embodiments, the contacts server 240 may be a storage location for user contacts. In this regard, a user may upload one or more user contacts to the contacts server 240 via, for example, network 225. For example, one or more user contacts associated with the user platform 245 and/or the user platform 250 may be uploaded to the contacts server 240 via network 225. Conversely, a user may update one or more user contacts maintained on the contacts server 240 via, for example, network 225, and download/transfer to the user platform 245, via, for example, network 225.

In one example, user contacts associated with the user platform 245 and/or the user platform 250 maintained on the contacts server 240 may be updated and then downloaded back to the user platform 245 and/or the user platform 250. Similarly, a user may exchange or share one or more user contacts with another user, using respective user platforms 245 and 250, in other words uploading or updating one or more user contacts between the user platforms, via, for example, network 225. As such, and as described below, one or more user contacts may be synchronized with, for example, contacts server 240 and/or between user platforms 245 and/or 250. Further, one or more user contacts may be received from the contacts server 240 by various network entities including apparatus 200.

The user platforms 245, 250 may also be of any type of device for storing, retrieving, computing, transmitting and receiving data. In some embodiments, user platforms 245, 250 may be embodied as a mobile communication device 10 of FIG. 1 or the like. Alternatively, the user platforms may be fixed, such as in instances in which a work station serves as a user platform. User platforms may be associated with one or more user contacts such that a user contact may be used to direct communications to the user platforms and a user of the user platform. In some embodiments, user contacts may direct communications to a central holding location (e.g., a server) that may be accessed by a user via user platforms 245, 250. For example, email may be directed by a user contact to a server for holding until a user can access the server via a user platform and retrieve the email. In the alternative, email may be directed to a server for holding by a user contact and subsequently transferred to a user platform. User platforms 245, 250 are representative of a plurality of user platforms, and as such any number of user platforms may be included in FIG. 2. In some embodiments, via the user platforms 245, 250, a user may access an example online service such as, but not limited to, a website, a social networking website, a website dedicated to users of software applications such as, for example, a game website, a blog website, a web feed, a widget, or the like, using a browser, a dedicated application, or the like.

User platform 250, as well as any other user platform, may also be associated with a phonebook 255. The phonebook 255 may include data including user contacts and additional associated information. The phonebook 255 may be stored on a memory device that is included with the user platform 255 or external to the user platform 250, similar to contacts server 240. As described below, the data within the phonebook 255 may be synchronized with, for example, a contacts server 240.

The apparatus 200 also includes a response receiver 230, a response comparator 232, an invitation generator 234, and a response table generator 236, which may be any means or device embodied in hardware, software, or a combination of hardware and software that is configured to carry out the respective functions as described herein. In an example embodiment, the processor 205 may include, or otherwise control the response/challenge receiver 230, the response/challenge comparator 232, the invitation/challenge generator 234, and the response/challenge table generator 236. In various example embodiments, the response/challenge receiver 230, the response/challenge comparator 232, and the invitation/challenge generator 234 may reside on a server, or other network device including a mobile terminal, such as mobile communication device 10 of FIG. 1.

The response/challenge receiver 230 may be configured to receive one or more responses accomplished by a user, and as such, may be embodied by various means, including user interface 215, communication interface 220, the processor 205, and/or the like. In this regard, a user may access and execute a software application, and accomplish one or more response(s)/challenges as a result of their execution of the software application. As used herein, “software application”, “software”, or “application” may be used interchangeably to refer to a game application, a word or other data processing application, media applications, media files (e.g., music, video, picture, podcast files, and/or the like) and/or the like. A software application may be organized by a developer of the software application to provide a user with an opportunity to accomplish various different responses. The software application may be accessed and/or executed using user platforms 245 and/or 250. In some embodiments, the software application may be accessed through an online service. In this regard and as an example, a user may access an online service to execute a software application, such as playing a video game, running a social media application, or other applications.

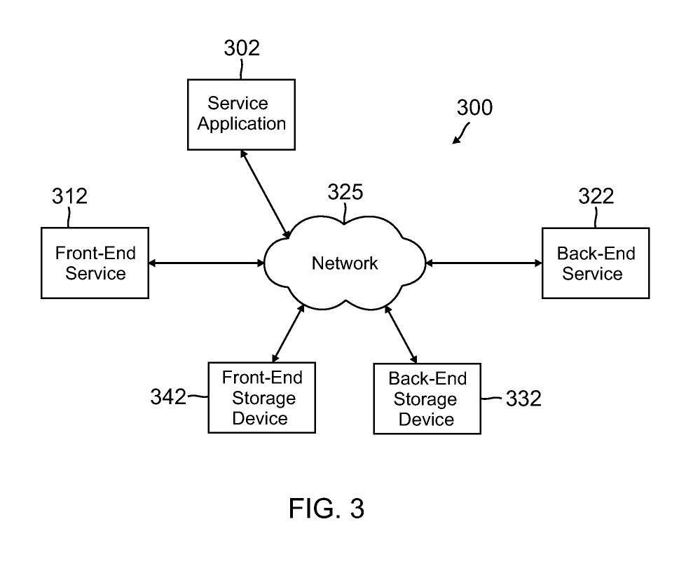

In this regard, and referring now to FIG. 3, an embodiment of a system in accordance with aspects of the present invention is illustrated. The system 300 of

FIG. 3 may include a service application 302, a front-end service 312, a back-end service 322, a back-end storage device 332, and a front-end storage device 342. The service application 302, the front-end service 312, the back-end service 322, the back-end storage device 332, and the front-end storage device 342 may be interconnected via the illustrated network 325, which may operate in similar manner to network 225.

The back-end service 322 may be embodied as or provided by apparatus 200 and the back-end service 322 may be an online service. The back-end storage device 332 and the front-end storage device 342 may operate in similar manner to the memory device 210, as discussed herein above. The back-end storage device 332 may store one or more response/invitation tables, invitations, and/or the like. The front-end storage device 342 may store information associated with the user, the user's contacts, other users of the software application, and/or the like.

The service application 302 may be a software or hardware application residing and operating on a platform, such as a computer, mobile terminal, or the like, that may be used to interact with the front-end service 312, the back-end service 322, and/or allow the front-end service 312 and the back-end service 322 to interact with each other. In some embodiments, one or more of the front-end service 312, the back-end service 322, the front-end storage device 342, and the back-end storage device 332 may reside and operate on a platform, such as a mobile terminal, computer, and/or the like. In some embodiments, the service application 302 may reside and operate on the apparatus 200, the user platforms 245, 250, or the like, and may operate in similar manner to apparatus 200, the user platforms 245, 250, or the like. The service application 302 may be downloaded to and/or installed on the platform. Via the service application 302, the front-end service 312 and the back-end service 322 may interact with each other to send and receive data, such as challenges/responses, user information, user contacts, and/or the like. The service application 302 may facilitate the gathering and/or storage of challenges/responses, usage attributes and/or user contacts for subsequent transmission to the front-end service 312 and/or the back-end service 322.

The service application 302 may also include authentication means to provide security features during the interaction between the front-end service 312 and the back-end service 322. The authentication means may be embodied as the processor 205, the front-end service 312, the back-end service 322, and/or the like, and, in one embodiment, may include computer instructions executed by one or more of the foregoing components. For example, the back-end service 322 may authenticate itself via the authentication means before exchanging information and/or accessing information maintained on the front-end storage device 342, and vice versa. Upon verification, the back-end service may be provided with access to, and allowed to exchange information with the front-end service 312, and vice versa. In some embodiments, the back-end storage device 332 and the front-end storage device 342 may be embodied in one storage device that may operate in similar manner to the memory device 210.

Referring back to FIG. 2, upon executing the software application, the user may receive or send a response/challenge. For example, the user may reach a certain user or users, provide challenge communications (e.g., “are you available?”), complete a certain level in a hierarchy of users, join special groups of users, gain a certain amount of familiarity, experience, proficiency level, and/or the like. The response/challenge receiver 230 may be configured to receive and/or retrieve one or more responses or challenges accomplished by a user. The one or more responses/challenges may be received and/or retrieved immediately upon being sent by a user or upon termination of the execution of the application by the user or by the application. In some embodiments, the response/challenge receiver 230 may be configured to store the one or more responses/challenges of the user in the memory device 210 to be retrieved at a later time to generate one or more invitations to the user's contacts to execute a portion of the software application.

In addition to receiving and/or retrieving the one or more responses of the user, the response/challenge receiver 230 may also receive and/or retrieve information regarding the software application to identify the response/challenge table associated with the software application. In some embodiments, one or more response/challenge tables may be stored in the memory device 210.

FIG. 2, the response/challenge comparator 232 may be configured to compare the one or more responses/challenges received and/or retrieved by the response receiver 230 with the entries of the response/challenge table identified by the response/challenge receiver 230 to identify the options available in generating invitations to the user's contacts. The response/challenge comparator 232 may receive one or more responses/challenges, compare the one or more received responses/challenges with the entries in the response/challenge table, and determine which portion(s) of the application and/or additional attributes or information related to the application to send via invitations based at least in part on the comparison. The response/challenge comparator 232 may be embodied by various means including the processor 205, which may execute computer instructions stored, for example, in memory device 210. In some embodiments, the response/challenge comparator 232 may also receive and/or retrieve information regarding the software application to identify the response/challenge table associated with the software application. The response/challenge comparator 232 may receive and/or retrieve the one or more responses/challenges received and/or retrieved by the response/challenge receiver 230 and compare them to the entries of the identified response/challenge table. The response/challenge comparator 232 may identify one or more entries corresponding to the one or more responses/challenges and thus determine the one or more trial versions, activation codes, number of times to send invitations to execute the software application, and/or any additional information associated with the one or more responses/challenges of the user in executing the software application.

The invitation/challenge generator 234 may be configured to generate one or more invitations and/or challenges based at least in part on the one or more entries identified by the response comparator 232. The invitation/challenge generator 234 may be embodied by various means including the processor 205, which may execute computer instructions stored, for example, in memory device 210. Upon accomplishing a response/challenge, the user may receive a request from the invitation/challenge generator 234 to send a portion of or the entire application as executed thus far to the user's contacts or potential contacts. The request may be provided immediately after the response, after the software application indicates to the user a termination of the execution or after the user terminates execution of the application. The user may desire to send one or more invitations at any moment such as, for example, upon receiving the requests, after terminating the execution of the application or after reaching a termination point of the application for a particular execution session. In other embodiments, the user may suspend the execution of the application, send one or more challenges or invitations, and then continue the execution of the application.

The challenge or invitation may be generated based at least in part on the one or more entries in the response table corresponding to the one or more responses of the user or challenger/inviter. Generating an invitation or challenge may also be based at least in part on the submission of various information from the user or challenger/inviter. As such, the user or challenger/inviter may be prompted by the invitation/challenger generator 234 to submit various types of information. In this regard, the user or challenger/inviter may be requested to submit a shown challenge, invitation, or proposal. As used herein, a “challenge” may refer to challenging one or more invitees to exceed or accomplish the response accomplished by the inviter. An invitation” may refer to inviting one or more users to challenge one or more users. For example, the inviter/challenger may have completed a certain level in the application in a certain amount of time. As such, the inviter/challenger may challenge or invite the one or more invitees or users to complete the same level in the same or better time. As another example, the inviter/challenger may have accrued a certain amount of points. As such, the inviter/challenger may invite/challenge the one or more invitees or other users to accrue the same or more amount of points. Additionally, the user or invitee/challenger may be requested to submit a hidden message to be displayed to the one or more invitees/challengers upon completion of the challenge/invitation. In some embodiments, the message may be gradually displayed as the invitee is completing the challenge. The message may include the identity of the inviter/challenger and may be any message desired by the inviter/challenger. In some embodiments, there may be a message in the event the invitee completes the challenge. In other embodiments, another message may be presented in the event the invitee/challenger fails to complete the challenge after a predetermined number of attempts. The present invention may be used for advertisement, marketing, education, and other purposes.

Further, the inviter/challenger may be requested by the invitation/challenge generator 234 to submit the contacts to whom the invitations to execute the application may be sent. As discussed above, the user or inviter may be accessing the application from an online service using user platforms 245 and/or 250. In this regard, the invitation/challenge generator 234 may be configured to access the phonebook 255 of the user platform 250 and/or 245. As such, the one or more invitees may be selected from the contacts stored in the phonebook 255. In other embodiments, the invitation/challenge generator 234 may be configured to access the contacts of the user, challenger, or inviter stored on a remote server, such as, for example, contacts server 240. In different embodiments, the user or inviter may be accessing the application from a website, such as, for example, a social network website.

The invitation/challenge generator 234 may be configured to access the contacts of the user or inviter maintained by the social network website. The invitation/challenge generator 234 may retrieve all necessary information regarding one or more contacts or potential contacts of the user (e.g. name, telephone number, email address, and/or the like) from the social network website and transfer the information to apparatus 200. The information may be stored in a temporary storage location on memory device 210 and/or the like. The invitation/challenge generator 234 may then use the information to generate the invitations/challenges. In other embodiments, the invitation/challenge generator 234 may generate the one or more invitations/challenges, as described in further detail, without the information of the contacts of the user, and forward the invitations/challenges to the social network website. The user, challenger, or inviter may then select the one or more individual contacts or group of contacts to send the invitations/challenges,

In the alternative, the social network website may automatically send the invitations and/or challenges. The invitation/challenge generator 234 may be configured to include information that may allow the social network website to automatically send the invitations/challenges. For example, the user may have a particular group or a sub-group on the social network website. As such, the invitation/challenge generator 234 may be configured to include information related to those groups. In further embodiments, the user may be accessing the software application from an online service dedicated to other users of the application, related or unrelated applications, and/or the like. In this regard, a similar approach described above with respect to the social network website may be applicable. As such, the invitation/challenge generator 234 may be configured to access these users as user's contacts or potential contacts. The invitation/challenge generator 234 may be configured to access and/or retrieve the user's contacts at various moments, such as, for example, upon the user accessing the software application, during the execution of the application, upon accomplishing an invitation, response or challenge, after terminating the execution of the application, and/or the like. Upon retrieving a selected user's contacts, the user may be requested to choose one or more contacts to receive the one or more invitations. As discussed above, the number of times to send the invitations is based at least in part on the response of the challenger/inviter or challengee and/or invitee as indicated in the response table. As such, the invitation/challenge generator 234 may set the maximum of invitations/challenges that may be sent to the user's contacts.

In some embodiments, the user may choose to send a default invitation and/or challenge and as such, may not submit any customized information. In this regard, the invitation/challenge generator 234 may submit all the information necessary to generate the invitation/challenge. Once the information has been received, the invitation/challenge generator 234 may proceed to compile the one or more invitations/challenges and send them to one or more invitees, challengees (challenge recipients), or a user's contacts. The one or more invitations/challenges may be embedded with information related to the user or inviter such as, for example, name, e-mail address, other identifiers, and/or the like. The one or more invitations/challenges may comprise a hyperlink and/or other means to access the trial version of the software application.

The invitation/challenge generator 234 may determine an expiration time for the invitation/challenge. In other embodiments, the invitations/challenges and/or the trial versions or portions of the software application may be indefinitely valid. The one or more invitations/challenges may be sent to one or more user's contacts using various communications methods such as, for example, short message service (SMS) message, multimedia messaging service (MMS) message, e-mail, instant messaging, other messaging protocol, and/or the like. The invitations may be directed by the invitation/challenge generator 234 to a server for holding until the one or more invitees can access the server via a user platform and retrieve the invitation/challenge. In the alternative, the invitation/challenge may be directed to a server for holding and subsequently transferred to a user platform of the invitees/challengees.

The invitation/challenge generator 234 may also maintain one or more records associating the user or inviter/challenger with the one or more invitations/challenges sent, along with additional information related to the one or more invitations/challenges and/or trial versions. As such, the user, challenger, or inviter may monitor the status of the invitations/challenge. The one or more records may be published to an online service website such as a website, a social networking website, a website dedicated to users of software applications such as, for example, a game website, a blog website, a dating website, a web feed, a widget, or the like, using a browser, a dedicated application, service, or the like, which the users may access. The user, invitee/challengee, or inviter/challenger may monitor what invitations/challenges have been sent, received, and/or opened. The user, challenger, or inviter may also monitor which invitations/challenges have been presented and what was the response. The user, challengee, invitee, challenger, or inviter may further determine which one or more invitations/challenges or responses have been forwarded to additional users. The additional users may be contacts of the user, invitee/challengee, or inviter/challenger (e.g. members of the phonebook, social network website contacts, and fellow users of the applications and/or the like).

The invitee/challenge may receive an invitation from the user, challenger, or inviter without knowing the identity of the user, challenger, or inviter, in other words, the identity of the user, challenger, or inviter may not be initially revealed to the invitee/challengee, or vice versa, or other suitable combinations and variations. The invitation/challenge may include a message, from the user, challenger, or invitee or a default message, challenging the invitee/challengee. The anonymous nature of the invitation/challenge may spark the curiosity of the invitee/challengee. In some embodiments, the invitation/challenge may be authenticated by the user platform of the invitee/challengee to verify that the invitation/challenge is from a trusted source. As such, an authentication means, similar to the one described above, may identify that the inviter/challenger is a member of invitee's or challengee's user contacts (phonebook contact, contact stored remotely on server, or social networking website contact, and/or the like) by analyzing the user, challenger, or inviter's information that may be embedded in the invitation/challenge, although not revealed to appeal to the curiosity of the invitee. For example, a note indicating “You know this person” may be presented after verifying the identity of the inviter/challenger. For example, if the authentication means identifies the inviter/challenger to be a member of the invitee's or challengee's user contacts (phonebook contact, contact stored remotely on server, or website (e.g. social networking website) contact and/or the like, the invitee/challengee may be shown or otherwise notified (e.g. by vibrating the user platform, showing a note, playing a sound, and/or the like or a combination thereof) that “You have been challenged to a quiz game. You know the person who has challenged you. Do you dare to find out who he or she is?” Alternatively, if the invitation/challenge is sent by a contact not previously known to the invitee/challengee, the notification may indicate, for example, “An anonymous person has sent you a proposal. To find out who he or she is, complete the challenge!” Nevertheless, the invitation/challenge may have been authenticated by the user platform of the invitee/challengee to verify that the invitation/challenge is from a trusted source. After the invitation/challenge has been authenticated, the invitee/challengee may open the invitation/challenge, access the trial version of the application, and execute the application. The invitee/challengee may be allowed to execute the application and attempt to accomplish a response or meet the criteria of a challenge/invitation a predetermined number of times. The invitee/challengee may accomplish a response or meet the criteria of the invitation/challenge defined by the inviter/challenger. As such, the identity of the inviter/challenger and/or the hidden message may be revealed to the invitee/challengee. The invitee/challengee may receive a request to send one or more invitations/challenges to contacts of the invitee/challengee and undergo the same process as described above. In some embodiments, the invitation/challenge generator 234 may be configured to determine whether the invitee/challengee has already received the particular free trial version being sent or any trial version of the software application and as such may prevent the user from receiving the same trial version multiple times.

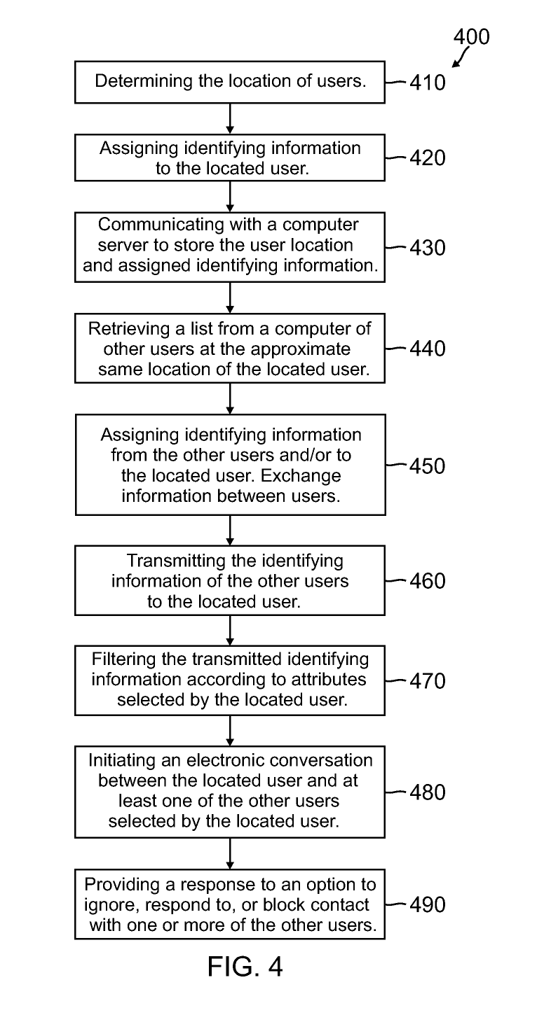

Referring to FIG. 4, a method 400 of the present invention may include a Step 410 of determining the location of users. Step 420 may comprise assigning identifying information to the located user. Another step, Step 430 may include communicating with a computer server to store the user location and assigned identifying information. A Step 440 may involve retrieving a list from a computer of other users at the same approximate location of the located user. Assigning identifying information from the other users to the located user comprises Step 450. Step 450 may also comprise assigning identifying information to other users or other configurations of exchanging information between users. A Step 460 may include transmitting the identifying information of the other users to the located user. Step 470 may involve filtering the transmitted identifying information according to attributes selected by the located user. Another step, Step 480 comprises initiating an electronic conversation between the located user and at least one of the other users selected by the located user. Yet another Step 490 comprises providing a response to an option to ignore, respond to, or block contact with one or more of the other users.

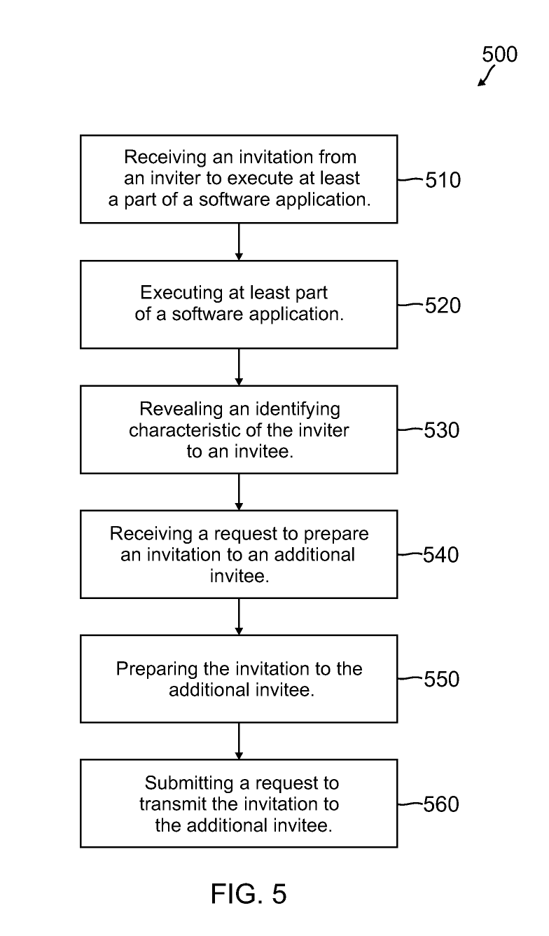

Another method 500 is shown in the flowchart of FIG. 5. Step 510 comprises receiving an invitation from an inviter to execute at least a part of a software application. Another Step 520 may comprise executing at least part of a software application. Yet another Step 530 may include revealing an identifying characteristic of the challenger/inviter to an invitee/challengee. An additional Step 540 may involve receiving a request to prepare an invitation to an additional invitee/challengee. Step 550 may comprise preparing the invitation to the additional invitee/challengee. A Step 560 may include submitting a request to transmit the invitation to the additional invitee/challengee.

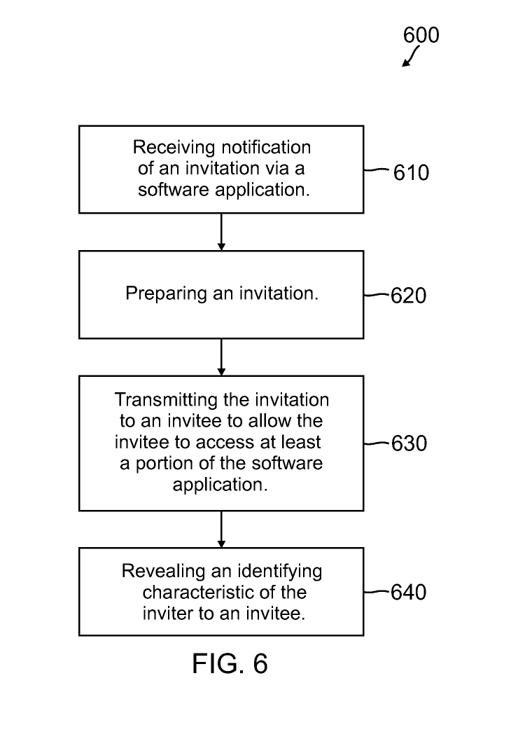

In FIG. 6, another method 600 according to the present invention is displayed. A Step 610 may comprise receiving notification of an invitation via a software application. Another Step 620 may involve preparing an invitation. Yet another step, Step 630 may include transmitting the invitation/challenge to an invitee/challengee to allow the invitee/challengee to access at least a portion of the software application. A Step 640 may comprise revealing an identifying characteristic of the inviter/challenger to an invitee/challengee.

It should be understood, of course, that the foregoing relates to exemplary embodiments of the invention and that modifications may be made without departing from the spirit and scope of the invention as set forth in the following claims. Furthermore, a method herein described may be performed in one or more sequences other than the sequence presented expressly herein. As another example, any reference to an invitation may be considered to be a reference to a challenge. Any reference to an inviter may be considered to be a reference to a challenger. Also, any reference to an invitee may be considered to also be a reference to a challengee.

We claim:

1. A method for operating a communications service, comprising:
determining the location of users;
assigning identifying information to the located user;
communicating with a computer server to store the user location and assigned identifying information;
retrieving a list from a computer of other users at the approximate same location of the located user;
assigning identifying information to the other users at the approximate same location of the located user;
transmitting the identifying information of the other users to the located user;
filtering the transmitted identifying information according to attributes selected by the located user;
initiating an electronic conversation between the located user and at least one of the other users selected by the located user.

2. The method of claim 1, wherein the communicating step occurs via one or more of MMS, SMS, text messaging, Internet, website, radio, telephone, telegraph, television, video display.

3. The method of claim 1, wherein the electronic conversation in the initiating step occurs via one or more of MMS, SMS, text messaging, Internet, website, radio, telephone, telegraph, television, video.

4. The method of claim 1, wherein the located user provides a response to an option to ignore, respond to, or block contact with one or more of the other users.

5. The method of claim 1, wherein the determining step comprises geo-positional searching, signal triangulation, and/or user registration.

6. The method of claim 1, wherein the users are one of members of a created virtual community network and non-members of the created virtual community network.

7. The method of claim 1, wherein the initiating step is performed while observing the located user.

8. The method of claim 1, wherein the located user and the at least one of the other users selected by the located user are located at the same location.

9. The c Method of claim 1, further comprising receiving an invitation from an inviter.

10. The method of claim 9, further comprising revealing an identifying characteristic of the inviter to an invitee.

11. The method of claim 10, further comprising revealing an identifying characteristic of the invitee to the inviter.

12. An apparatus, comprising:
a processor; the processor configured to receive an invitation from an inviter to execute at least a part of a software application;
execute at least part of the software application; and
reveal an identifying characteristic of the inviter to an invitee.

13. The apparatus of claim 12, wherein the identity of the inviter is revealed.

14. The apparatus of claim 12, wherein an identifying characteristic of the invitee is revealed to the inviter.

15. The apparatus of claim 12, wherein the processor is further configured to receive a request to prepare an invitation to an additional invitee;
prepare the invitation to the additional invitee;
submit a request to transmit the invitation to the additional invitee; and
monitor the status of the invitation.

16. The apparatus of claim 12, further comprising a challenge generator that generates a challenge to elicit a response from a first viewer, one or more second viewers, one or more third viewers and one or more nth viewers;
a challenge-response module that determines whether the first viewer, the one or more second viewers, the one or more third viewers, and the one or more nth viewers have entered a response to the challenge to confirm whether the challenge has been reviewed by the first viewer, the one or more second viewers, the one or more third viewers, and the one or more nth viewers respectively; and
a report generation module that generates a response report for each of the first viewer, the one or more second viewers, the one or more third viewers, and the one or more nth viewers based on the response from the first viewer the one or more second viewers, the one or more third viewers, and the one or more nth viewers.

17. A computer program product comprising computer-readable program code portions comprising:
a first program code portion configured to receive notification of an invitation via a software application;
a second program code portion configured to prepare an invitation; and
a third program code portion configured to transmit the invitation to an invitee to allow the invitee to access at least a portion of the software application.

18. The computer program product of claim 17, wherein the third program code portion comprises a program code portion to transmit the invitation via short message service message, multimedia messaging service message, electronic mail, or other messaging protocol.

19. The computer program product of claim 17 wherein the third program code portion is configured to reveal an identifying characteristic of the inviter to an invitee.

20. The computer program product of claim 17, further comprising a fourth program code portion for confirming viewing of the invitation by the invitee.
